(19) United States
(12) Patent Application Publication
(10) Pub. No.: US 2016/0068761 A1
(43) Pub. Date: Mar. 10, 2016

(54) ETHANOL-GASOLINE SEPARATION PROCESS

(71) Applicant: Harry TUCCI, Spring City, PA (US)

(72) Inventor: Harry TUCCI, Spring City, PA (US)

(21) Appl. No.: 14/481,231

(22) Filed: Sep. 9, 2014

(51) Int. Cl. C10G 31/08; B01D 29/56; C10L 1/06; B01D 17/02

(52) U.S. Cl. CPC C10G 31/08; B01D 17/0214; B01D 29/56; C10L 1/06; C10L 2290/56; C10L 2290/541; C10L 2290/547

(57) ABSTRACT

An extraction system is provided to extract ethanol from an ethanol-gasoline blend fuel. The extraction system may provide a settling vessel for a mixture of water and the ethanol-gasoline blend fuel. The settling vessel may include a main body and a settling valve. The main body forms a cavity for receiving the mixture through an aperture near the top portion of the main body. The settling valve may extend off the main body near a bottom portion thereof, wherein the settling valve may be adapted for controlling the flow of the mixture or portions thereof positioned within the settling vessel.

### BACKGROUND OF THE INVENTION

The present invention relates to fluid separation methods and, more particularly, to separation of ethanol from ethanol-gasoline blended fuel.

Ethanol-blended gasoline is frequently mandated by law. However, classic, vintage, collector, older and antique vehicles and engines do not have fuel system components that can stand up to the highly corrosive effects of ethanol-blended gasoline. Ethanol contains soluble and insoluble contaminants that dissolves rubber & plastic parts over time and draws water into the fuel. These problems are present in both 2 & 4 cycle engines that sit or are not run for periods of time as such fuel systems do not have the components to internally separate ethanol-gasoline blends. Though even if they did, such components would draw energy from the vehicle, would need to introduce pressure to control the process, and would not provide the ability to visually monitor or gage the system of ethanol-gasoline separation process. As ethanol fuels age, gums will form in the fuel tank, fuel lines, & carburation system. Since ethanol is a strong solvent it will begin to breakdown these gums and thereby allow the resultant particulates to clog the fuel system.

Fuel stabilizers and other additives can be added to such fuel systems for breaking down the ethanol, but such additives still leave some form of the ethanol in the fuel. Moreover, such additives may have an insidious impact on the fuel systems of classic, vintage, collector and antique vehicles.

As can be seen, there is a need for a method of removing ethanol from ethanol-based fuel prior to its reception into the fuel systems of classic, vintage, collector, older and antique vehicles and older engine systems.

### SUMMARY OF THE INVENTION

In one aspect of the present invention, a method for extract ethanol from an ethanol-gasoline blend fuel, comprising the steps of: providing a settling vessel having a main body forming a cavity; an aperture disposed within a top portion of the main body, wherein the aperture communicates with the cavity; and a settling valve disposed near a bottom portion of the main body, wherein the settling valve communicates with the cavity; securing the settling valve in a closed position; pouring a predetermined amount of the ethanol-gasoline blend fuel into the cavity through the aperture; pouring a predetermined amount of water into the cavity through the aperture; waiting a sufficient amount of time for the ethanol of the ethanol-gasoline blend fuel to form an ethanol-water mixture, wherein the ethanol-water mixture stratifies to form a substantially distinct lower layer, and wherein a separate resulting ethanol-free gasoline forms a substantially distinct upper layer within the cavity; and moving the settling valve from the closed position to an open position for a sufficient time so that the entirety of the lower layer of the ethanol-water mixture substantially flows out of the cavity through the settling valve.

In another aspect of the present invention, a system for extracting ethanol from an ethanol-gasoline blend fuel comprises: a settling vessel comprising a main body forming a cavity; an aperture disposed within a top portion of the main body, wherein the aperture communicates with the cavity; and a settling valve disposed near a bottom portion of the main body, wherein the settling valve communicates with the cavity, and wherein the settling valve is positionable from an open position to a closed position; a water source operably connected to the aperture; a two-prong channel connected to the settling valve, wherein a first prong provides a first valve while a second prong provides a second valve so that the flow out of the settling valve through the first prong and the second prong is operably controlled by the first and second valves respectively; an ethanol-free gasoline vessel connected to the second prong; an ethanol-water mixture vessel connected to the first prong; a plurality of separation filters to the ethanol-water mixture vessel so that the ethanol-water mixture within the ethanol-water mixture vessel is stratified into an ethanol portion and a water portion; and a water vessel and an ethanol vessel connected to the plurality of separation filters so that the ethanol portion flows to the ethanol vessel and the water portion flows to the water vessel.

These and other features, aspects and advantages of the present invention will become better understood with reference to the following drawings, description and claims.

### BRIEF DESCRIPTION OF THE DRAWINGS

FIG. 1 is a schematic diagram of an exemplary embodiment of the present invention;

FIG. 2 is a schematic diagram of an exemplary embodiment of a first step of the present invention;

FIG. 3 is a schematic diagram of an exemplary embodiment of a second step of the present invention;

FIG. 4 is a schematic diagram of an exemplary embodiment of a third step of the present invention; and

FIG. 5 is a schematic diagram of an exemplary embodiment of a fourth step of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an extraction system to extract ethanol from an ethanol-gasoline blend fuel. The extraction system may provide a settling vessel for a mixture of water and the ethanol-gasoline blend fuel. The settling vessel may include a main body and a settling valve. The main body forms a cavity for receiving the mixture through an aperture near the top portion of the main body. The settling valve may extend off the main body near a bottom portion thereof, wherein the settling valve may be adapted for controlling the flow of the mixture or portions thereof positioned within the settling vessel.

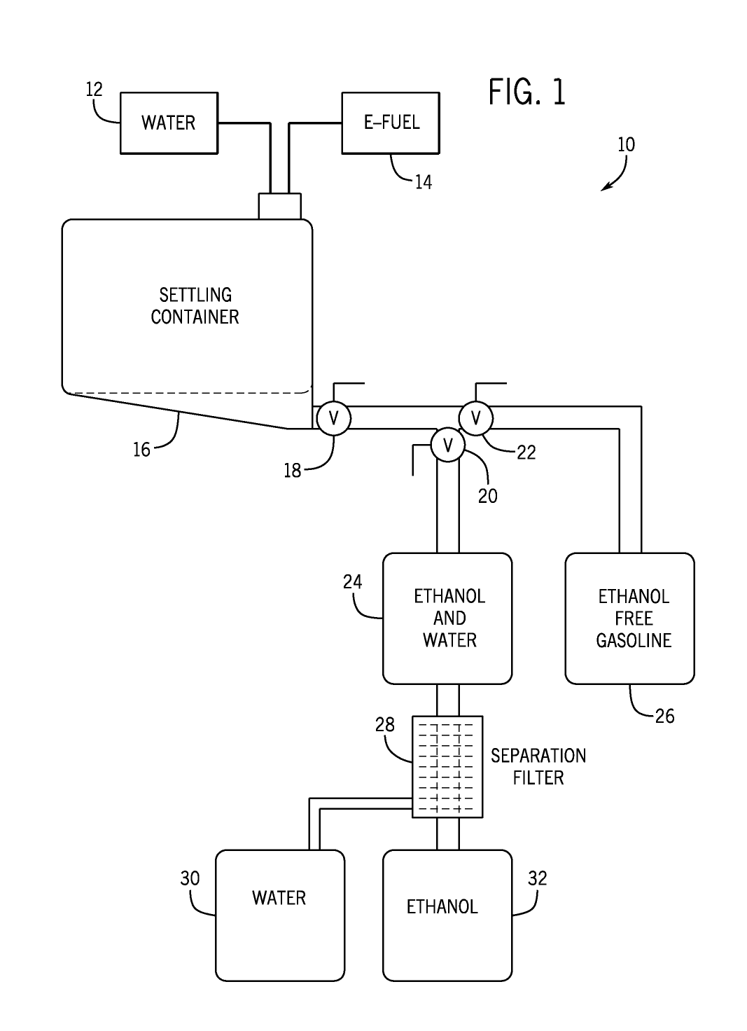

FIG. 1 illustrates an extraction system 10 embodying a method of the present invention to extract ethanol from an ethanol-gasoline blend fuel 34. The extraction system 10 may provide a settling vessel 16 for the mixture of water 36 from a water source 12 and the ethanol-gasoline blend fuel 34 from an ethanol-gasoline blend fuel source 14.

The ethanol-gasoline blend fuel 34 may include ethanol fuel, biofeul gasoline with an ethanol additive, and other forms of ethanol mixed with gasoline. For gasoline blends, the blend may range from 10% ethanol and 90% gasoline (E10), 25% ethanol and 75% gasoline (E25) and higher.

The settling vessel 16 may include a main body forming a cavity for receiving a fluid and a spout extending off a front portion near a bottom portion of the main body. The settling vessel 16 may provide an aperture formed in a top portion in communication with the cavity. The settling vessel 16 may provide a settling valve 18 attached to the spout, wherein the settling valve 18 may be adapted for controlling the flow of the fluid positioned within the settling vessel 16 out of the spout. The bottom portion of the settling vessel 16 may be oriented at an angle from a horizontal surface (the floor) so as to be lower near the spout, relative to the aperture, than the remainder of the bottom portion.

The settling valve 18 may be moved from a closed position to an open position, and vice versa. In the closed position, the flow of the fluid may be approximately reduced to zero so that the fluid is stored within the cavity. In the open position, the flow of the fluid (positioned within the settling vessel 16) out of the spout is controllably promoted.

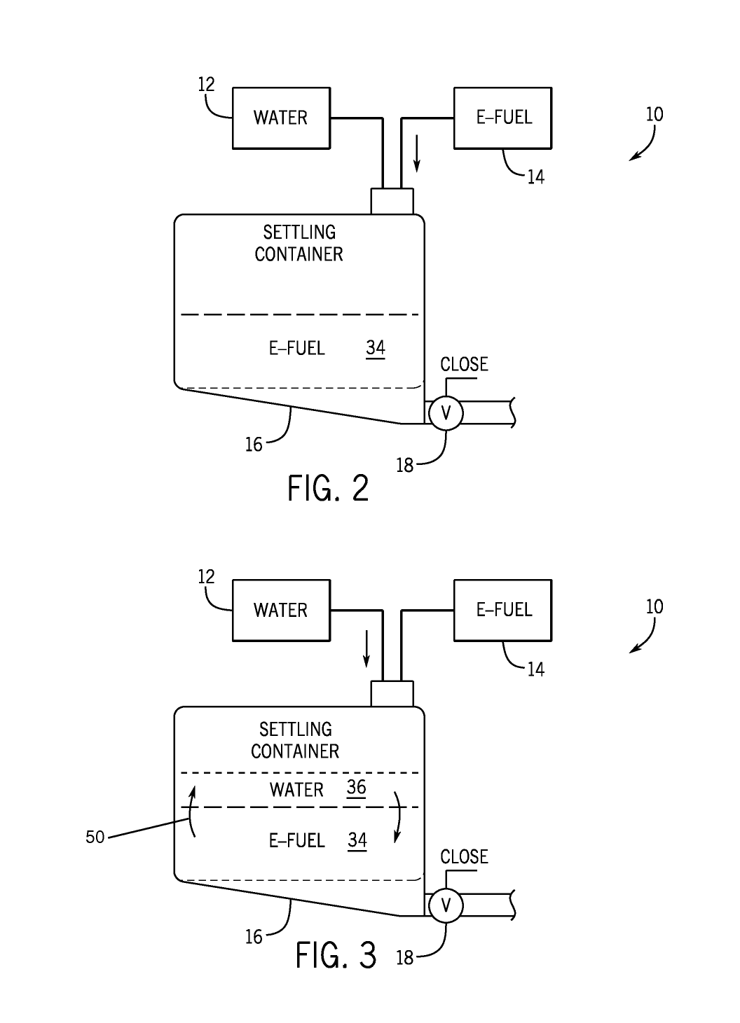

Referring to FIG. 2, a first step in the method of extracting ethanol from the ethanol-gasoline blend fuel 34 may include adding ethanol-gasoline blend fuel 34 from the blend fuel source 14 and into the cavity of the settling vessel 16 while the settling valve 18 is in the closed position.

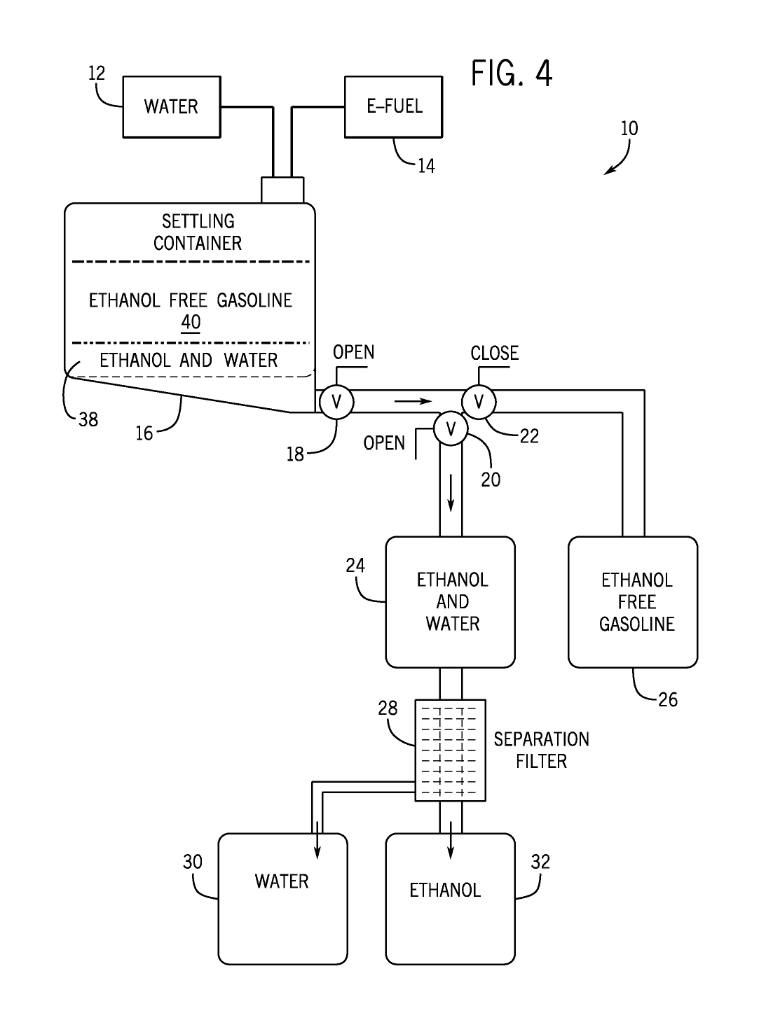

A second step, illustrated in FIGS. 3 and 4, mixes water 36 to the ethanol-gasoline blend fuel 34 within the cavity so as to form a predetermined mixture 50 of a predetermined range of the amount of water 36 and of a predetermined range of the amount of ethanol-gasoline blend fuel 34. The predetermined ranges are a function of percentage of ethanol to the percentage of gasoline of the ethanol-gasoline blend fuel 34 (e.g., E10 vs. E25, etc.). In other words, multiply the percent of ethanol by the volume of the ethanol-gasoline blend fuel 34 to be treated in quarts or pints to determine the amount of water 36 to be added. As an example, if we would want to treat four gallons or 16 quarts of ethanol E10 fuel, then we would multiply the 16 quarts by 10% and add 1.6 quarts of water 36 to the ethanol.

Because ethanol is hydrophilic and gasoline 40 is hydrophobic, within the predetermined mixture 50, the ethanol from the ethanol-gasoline blend fuel 34 dissolves in the water 36 to form an ethanol-water mixture 38, resulting in a separate ethanol-free gasoline 40, as illustrated in FIG. 4. The ethanol-free gasoline 40 is then stratified from the ethanol-water mixture 38 within the cavity because the ethanol-free gasoline 40 has a relatively smaller specific gravity so as to form an upper layer while the relatively-larger specific gravity of the ethanol-water mixture 38 forms a lower layer, as illustrated in FIG. 4.

A third step in the method, as illustrated in FIG. 4, involves moving the settling valve 18 to the open position for a predetermined time so that the entire lower layer of the ethanol-water mixture 38 may substantially flow through the spout; and then the settling valve 18 is moved to the closed position so that the upper layer of ethanol-free gasoline 40 is substantially stored in the settling vessel 16. A user may then empty a portion of the ethanol-free gasoline 40 within the settling vessel 16 to fill the fuel systems of classic, vintage, collector, older and antique vehicles without worrying about the deleterious impact of the soluble and insoluble contaminants of ethanol.

In certain embodiments, the extraction system 10 may provide a two-pronged channel connected to the settling valve 18. The two-pronged channel may provide a first prong terminating in a first valve 20 and a second prong terminating in a second valve 22. Both valves 20, 22 may be moved from a closed position to an open position, and vice versa. In the closed position, the flow of the fluid in the communicating prong may be reduced to approximately zero. In the open position, the flow of the fluid in and through the communicating prong is controllably promoted

The first valve 20 may be connected to an ethanol-water mixture vessel 24. The ethanol-water mixture vessel 24 may include a main body forming a cavity for receiving the ethanol-water mixture 38 and an aperture formed in a top portion in communication with the cavity via the first valve 20. The ethanol-water mixture vessel 24 may form a closable opening in communication with the cavity formed in a bottom of the main body.

In an alternative embodiment, the closable opening may be connected to a plurality of separation filters 28. The closable opening may be adapted to move from a closed position to an open position so that the ethanol-water mixture 38 received within the cavity of the ethanol-water mixture vessel 24 may controllably flow to the plurality of separation filters 28. The closable opening may be adapted to move from the open position to the closed position to stymie such flow so that the ethanol-water mixture 38 stores in the cavity of the ethanol-water mixture vessel 24.

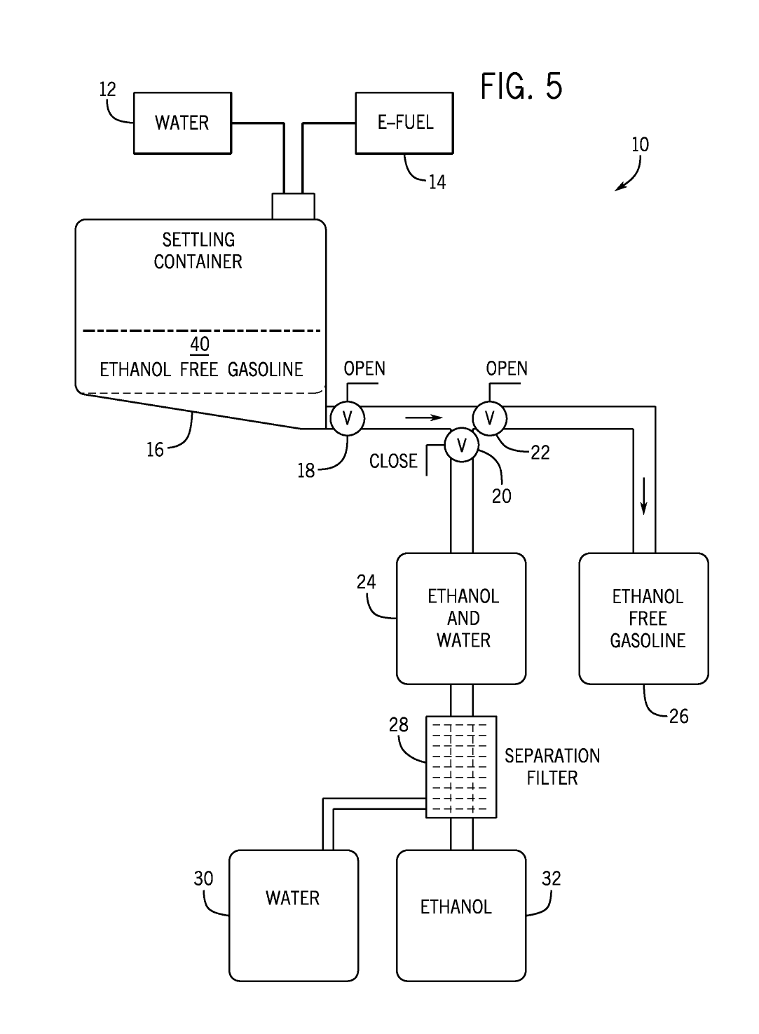

The plurality of separation filters 28 may be adapted to separate an ethanol portion and a water portion from the ethanol-water mixture 38 so that the water portion is either absorbed by the plurality of filters 28 or flows to a water vessel 30 and the ethanol portion flow to an ethanol vessel 32, as illustrated in FIGS. 4 and 5. The water portion received in the water vessel 30 may be used to subsequent iterations of the second step by or as the water source 12, wherein the water portion may be move manually, automatically, by pump or the like.

The second valve 22 may be connected to an ethanol-free gasoline vessel 26. The ethanol-free gasoline vessel 26 may include a main body forming a cavity for receiving the ethanol-free gasoline 40 and an aperture formed in a top portion in communication with the cavity via the second valve 22.

In certain embodiments, the third step in the method, as illustrated in FIG. 4, may include moving the second valve 22 to the closed position and moving the first valve 20 to the open position so that the ethanol-water mixture 38 flowing through the spout is substantially received in the cavity of the ethanol-water mixture vessel 24 with the closable opening in the closed position.

In an alternative embodiment of the third step, the closable opening is moved to the open position so that substantially all the ethanol-water mixture 38 flows through the plurality of separation filters 28.

In a fourth step of the method, as illustrated in FIG. 5, the first valve 20 is moved to the closed position while the second valve 22 is moved to the open position. Then the settling valve 18 is moved to the open position for a predetermined time so that the entire upper layer of the ethanol-free gasoline 40 may substantially flow through the spout, and into the ethanol-free gasoline vessel 26. The received ethanol-free gasoline 40 may then be used in the fuel systems of classic, vintage, collector, older and antique vehicles without worrying about the deleterious impact of the soluble and insoluble contaminants of ethanol.

It should be understood, of course, that the foregoing relates to exemplary embodiments of the invention and that modifications may be made without departing from the spirit and scope of the invention as set forth in the following claims.

What is claimed is:

1. A method for extracting ethanol from an ethanol-gasoline blend fuel, comprising the steps of:
providing a settling vessel having a main body forming a cavity; an aperture disposed within a top portion of the main body, wherein the aperture communicates with the cavity; and a settling valve disposed near a bottom portion of the main body, wherein the settling valve communicates with the cavity;
securing the settling valve in a closed position;
pouring a predetermined amount of the ethanol-gasoline blend fuel into the cavity through the aperture;
pouring a predetermined amount of water into the cavity through the aperture;
waiting a sufficient amount of time for the ethanol of the ethanol-gasoline blend fuel to form an ethanol-water mixture, wherein the ethanol-water mixture stratifies to form a substantially distinct lower layer, and wherein a separate resulting ethanol-free gasoline forms a substantially distinct upper layer within the cavity; and
moving the settling valve from the closed position to an open position for a sufficient time so that the lower layer of the ethanol-water mixture substantially flows out of the cavity through the settling valve, thereby isolating the ethanol-free gasoline within the cavity.

2. The method of claim 1, furthering including providing a water source for providing the predetermined amount of water.

3. The method of claim 2, further including connecting a two-prong channel to the settling valve, wherein a first prong provides a first valve while a second prong provides a second valve so that the flow out of the settling valve through the first prong and the second prong is operably controlled by the first and second valves respectively.

4. The method of claim 3, further including connecting an ethanol-free gasoline vessel to the second prong.

5. The method of claim 4, further including connecting an ethanol-water mixture vessel to the first prong.

6. The method of claim 5, further including connecting a plurality of separation filters to the ethanol-water mixture vessel so that the ethanol-water mixture within the ethanol-water mixture vessel is stratified into an ethanol portion and a water portion.

7. The method of claim 6, further including connecting a water vessel and an ethanol vessel to the plurality of separation filters so that the ethanol portion flows to the ethanol vessel and the water portion flows to the water vessel.

8. The method of claim 7, further including moving the water portion from the water vessel to the water source.

9. A system for extracting ethanol from an ethanol-gasoline blend fuel, comprising:
a settling vessel comprising
a main body forming a cavity;
an aperture disposed within a top portion of the main body, wherein the aperture communicates with the cavity; and
a settling valve disposed near a bottom portion of the main body, wherein the settling valve communicates with the cavity, and wherein the settling valve is positionable from an open position to a closed position; and
a water source operably connected to the aperture.

10. The system of claim 9 further including:
a two-prong channel connected to the settling valve, wherein a first prong provides a first valve while a second prong provides a second valve so that the flow out of the settling valve through the first prong and the second prong is operably controlled by the first and second valves respectively;
an ethanol-free gasoline vessel connected to the second prong; and
an ethanol-water mixture vessel connected to the first prong.

11. The system of claim 10 further including a plurality of separation filters to the ethanol-water mixture vessel so that the ethanol-water mixture within the ethanol-water mixture vessel is stratified into an ethanol portion and a water portion.

12. The system of claim 11, further including a water vessel and an ethanol vessel connected to the plurality of separation filters so that the ethanol portion flows to the ethanol vessel and the water portion flows to the water vessel.

13. The system of claim 12, further including a means of moving the water portion from the water vessel to the water source.

14. A system for extracting ethanol from an ethanol-gasoline blend fuel, comprising:
a settling vessel comprising
a main body forming a cavity;
an aperture disposed within a top portion of the main body, wherein the aperture communicates with the cavity; and
a settling valve disposed near a bottom portion of the main body, wherein the settling valve communicates with the cavity, and wherein the settling valve is positionable from an open position to a closed position;
a water source operably connected to the aperture;
a two-prong channel connected to the settling valve, wherein a first prong provides a first valve while a second prong provides a second valve so that the flow out of the settling valve through the first prong and the second prong is operably controlled by the first and second valves respectively;
an ethanol-free gasoline vessel connected to the second prong;
an ethanol-water mixture vessel connected to the first prong;
a plurality of separation filters to the ethanol-water mixture vessel so that the ethanol-water mixture within the ethanol-water mixture vessel is stratified into an ethanol portion and a water portion; and
a water vessel and an ethanol vessel connected to the plurality of separation filters so that the ethanol portion flows to the ethanol vessel and the water portion flows to the water vessel.

15. The system of claim 14, further including a means of moving the water portion from the water vessel to the water source.
